(19) United States
(12) Patent Application Publication
(10) Pub. No.: US 2007/0146732 A1
(43) Pub. Date: Jun. 28, 2007

(54) METHOD AND SYSTEM FOR GENERATING JOB PROFILES

(75) Inventors: KEVIN F. PIAZZA, Irvine, CA (US); MARTIN MARTINEZ, Irvine, CA (US); CRAIG MAZZAGATTE, Irvine, CA (US); DON HIDEYASU MATSUBAYASHI, Irvine, CA (US); STEVE YASUHIRO MUTO, Irvine, CA (US); SUMITA KUMAR, Irvine, CA (US)

Correspondence Address: CANON U.S.A. INC. INTELLECTUAL PROPERTY DIVISION, 15975 ALTON PARKWAY, IRVINE, CA, 92618-3731, US

(73) Assignee: CANON DEVELOPMENT AMERICAS, INC., Irvine, CA (US)

(21) Appl. No.: 11/613,429

(22) Filed: Dec. 20, 2006

Related U.S. Application Data
(60) Provisional application No. 60/753,097, filed on Dec. 22, 2005.

(51) Int. Cl. G06F 3/12

(52) U.S. Cl. 358/1.1; 358/1.15

(57) ABSTRACT

A method and system for generating a job profile set, the method and system comprising receiving identification information, receiving device information, retrieving at least one job profile based on the received identification information and the received device information, and generating a job profile set, wherein the generated job profile set includes the at least one job profile.

### CROSS-REFERENCE TO RELATED PATENT APPLICATION

This application claims the right of priority under 35 U.S.C. § 119(e) based on the U.S. Provisional Patent Application Ser. No. 60/753097, filed Dec. 22, 2005, which is incorporated by reference herein in its entirety as if fully set forth herein.

### BACKGROUND OF THE INVENTION

1. Field of the Invention

The present invention relates to obtaining job profiles for operating a multifunction device, and more particularly, obtaining job profiles that are tailored to the capabilities of the intended multifunction device.

2. Description of the Related Art

Multifunction peripheral (MFP) devices have become increasingly popular for copying, scanning, printing and faxing. Due to their increasing capabilities, users typically must first specify their desired device configurations and job attributes prior to performing a task. For instance, in order to scan a job at a multifunction device, a user often has to navigate through several configuration setting screens on the device's user interface, with each screen offering a multitude of different options buttons from which the user needs to choose in order to configure and initiate the scan job. Thus, it can become extremely cumbersome and time-consuming to configure each job individually. Therefore, it is desirable to set up predefined job profiles and choose from these job profiles when an operation at a multifunction device is needed.

Various efforts have been made to overcome the foregoing problem. U.S. Pat. No. 6,459,499 describes a system for scanning a document and sending a corresponding image file to a remote recipient using a software autosend utility that accesses predefined profiles of potential recipients. The predefined profiles including transport protocols and image scanning characteristics (e.g., black and white, 8-bit color, 16-bit color, etc.) for such recipients. The system allows a user to scan a document using scanning characteristics corresponding to a remote recipient and to send the resulting image file to the remote recipient using an appropriate file transport protocol.

U.S. Patent Publication No. 2004/0070630 describes a method for allowing a user to input display capability information (a menu item name) and job capability information (functions such as copying and faxing, or paper size) for each multifunction apparatus into a distribution server. The display capability information and job capability information of the multifunction apparatus is displayed so that personalized menu information can be generated. In one scenario, when menu information is needed, the user presses a menu operating key from an operating panel of the multifunction device. Upon requesting the menu information, the user ID and password are transmitted to the network. Then, the menu information processor obtains the menu information corresponding to the user ID from the menu information stored in the hard disk. In other words, users may select their personal menus via the multifunction device.

In another embodiment of U.S. Patent Publication No. 2004/0070630, the system can be configured so as to enable the distribution server to automatically collect display capability information and job capability information via the network. This allows the distribution server to obtain display capability information and job capability information from each multifunction device on a network without user interference.

One shortcoming of the above described methods is that the user job profiles are not tailored to the capabilities of the intended MFP device. In some circumstances, the user job profiles may not be applicable for the intended MFP device. For instance, the paper type associated with a particular job profile may be legal-size, while legal-size paper is not available at an intended MFP device. Therefore, it would be desirable to provide a method for obtaining predefined job profiles corresponding to the MFP device attributes.

### SUMMARY OF THE INVENTION

The present invention addresses the foregoing needs by providing a system for obtaining job profiles based on the device capabilities. In one embodiment, users predefine their job profiles and store the job profiles in a profile database. The job profiles may be created from a client desktop application or at the control panel of a multifunction device. To execute a job on a particular multifunction device (MFP), a user enters the user's identification information (e.g., user name and password) at the MFP and the MFP transmits this information to a server. The MFP also transmits its device information, such as available paper size and available image resolution, to the server.

The server, based on the received user's identification information, obtains any job profiles in the profile database that are associated with the user's identification information. After obtaining the job profiles, the server then generates a job profile set from the obtained profiles based on the received device information by matching the job profile with the device information. The job profile set is then presented to the user, allowing the user to select an appropriate job profile for the job.

Further features of the present invention will become apparent from the following description of exemplary embodiments (with reference to the attached drawings).

### BRIEF DESCRIPTION OF THE DRAWINGS

FIG. 1 is an exemplary illustration of a network environment in which the present invention is implemented.

FIG. 2 is an exemplary illustration of a detailed block diagram of the internal architecture of the multifunction device shown in FIG. 1.

FIG. 3 is an exemplary illustration of a detailed block diagram of the internal architecture of the server shown in FIG. 1.

FIG. 4A is an exemplary illustration of a graphical user interface of a profile application for viewing a job profile.

FIG. 4B is an exemplary illustration of a graphical user interface of a profile application for configuring a job profile.

FIG. 5 is an exemplary illustration of a table defining job parameters and their associated job capabilities.

FIG. 6 is an exemplary illustration of job profiles stored in the profile database of FIG. 1.

FIG. 7 is an exemplary illustration of job capability information of the MFP device shown in FIG. 1.

FIG. 8 is a flowchart depicting the operation for generating job profiles from the MFP device shown in FIG. 1.

FIG. 9 is a flowchart depicting the operation for generating job profiles from the client shown in FIG. 1.

### DESCRIPTION OF THE EMBODIMENTS

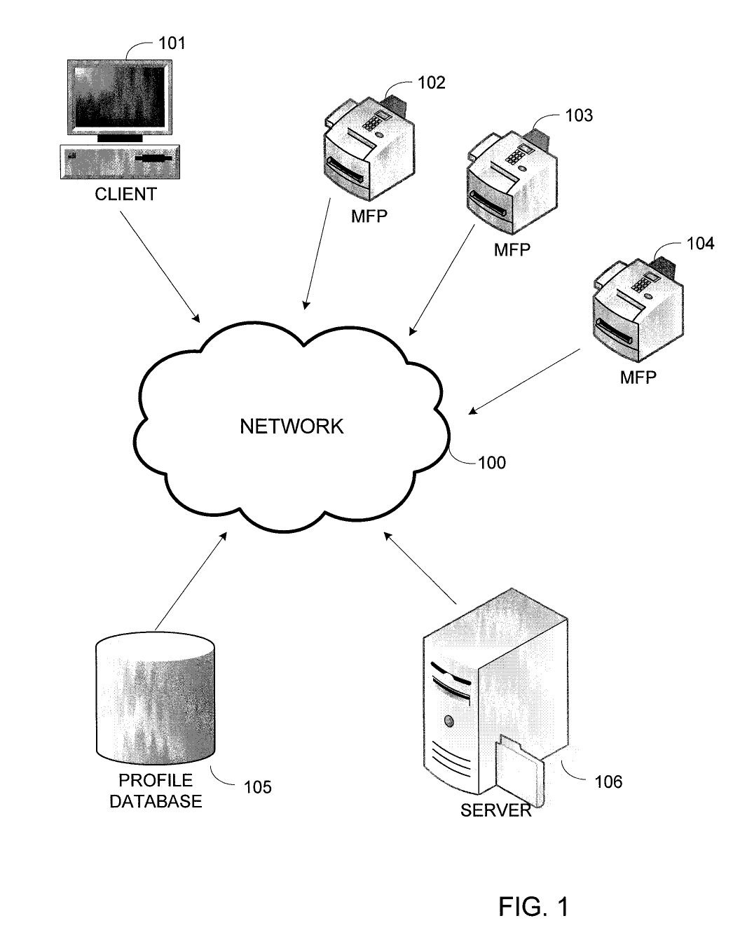

FIG. 1 depicts an example of a network environment in which the present invention may be employed. Network 100 is a Local Area Network (LAN), but is not limited to such, and any network environment that would enable practice of the present invention is applicable. As shown in FIG. 1, network 100 provides for communication between various entities. Each of the entities, 101 to 106, can communicate bi-directionally with each other via network 100. For instance, print data may be transferred from client 101 via network 100 to multifunction peripherals (MFPs) 102-104 and MFPs 102-104 can send scan data to client 101 via network 100. Client 101 is a personal computer, however, any device with sufficient processing capability that is capable of transmitting and receiving data from network 100, such as a personal digital assistant (PDA) or a mobile phone, may be utilized. Also connected to network 100 are profile database 105 and server 106. Profile database 105 allows server 106 to store and obtain job profiles. Each of these entities in FIG. 1 will be explained in further detail below.

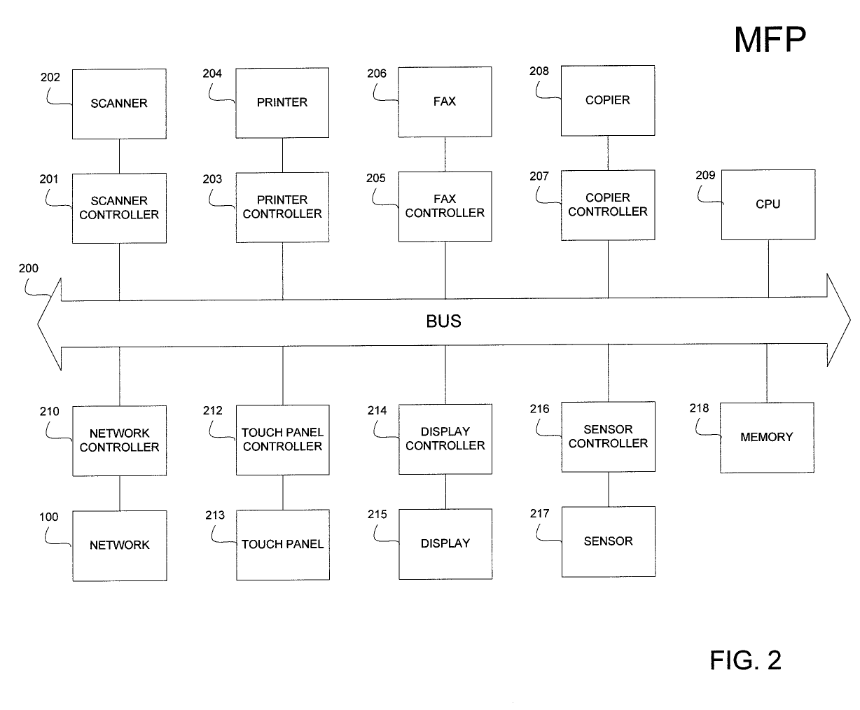

FIG. 2 is a representational view of the internal architecture of MFPs 102-104. MFPs 102-104 include central processing unit (CPU) 209, interfaced to bus 200. Also interfaced to bus 200 are scanner controller 201 to scanner 202, printer controller 203 to printer 204, fax controller 205 to fax 206, copier controller 207 to copier 208, network controller 210 to network 211, touch panel controller 212 to touch panel 213, display controller 214 to display 215, sensor controller 216 to sensor 217, and memory 218.

Memory 218, such as random access memory (RAM), interfaces to bus 200 to provide CPU 209 with access to memory storage for computer executable process steps. In addition, memory 218 provides temporary storage for data such as image files and job profiles for access by CPU 209.

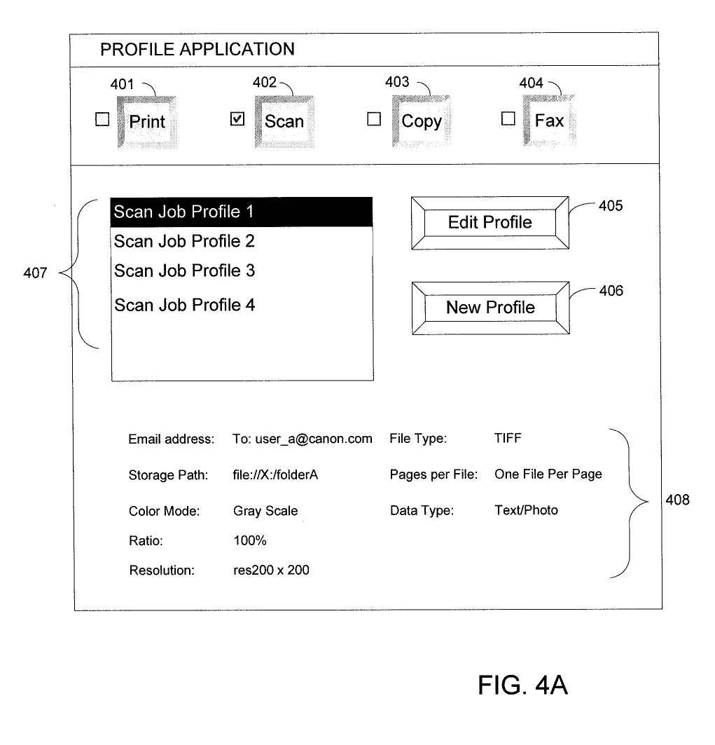

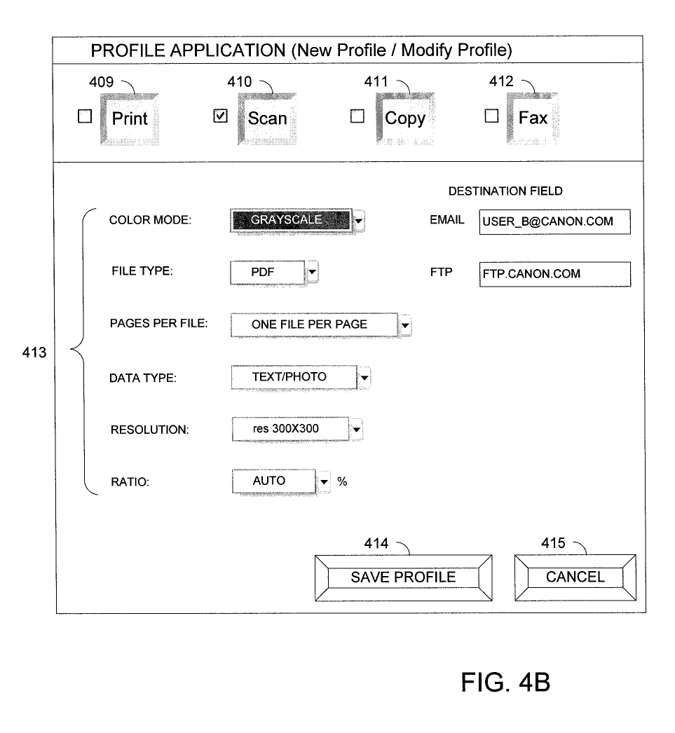

Job profiles are explained in more detail below in connection with FIG. 4. Generally speaking, job profiles include a set of predefined job parameters for various job functions. Job profiles can also include other types of information such as recipient information for transporting image data created by an MFP device.

Scanner controller 202 controls scanner 201 for scanning a document and storing the scanned image data in memory 218. Printer controller 203 controls printer 204 for printing a document stored in memory 218. Fax controller 205 controls fax 206 for facsimile transmission. Copier controller 207 controls copier 208 for reproducing image data. Touch panel controller 212 controls touch panel 213 for sending instruction commands to CPU 209. Display controller 214 control for displaying information on display 215. Sensor controller 216 controls sensor 217 for monitoring status of an MFP such as available papers or available ink of the MFP. Network controller 210 enables the MFP to communicate with other entities on network 100.

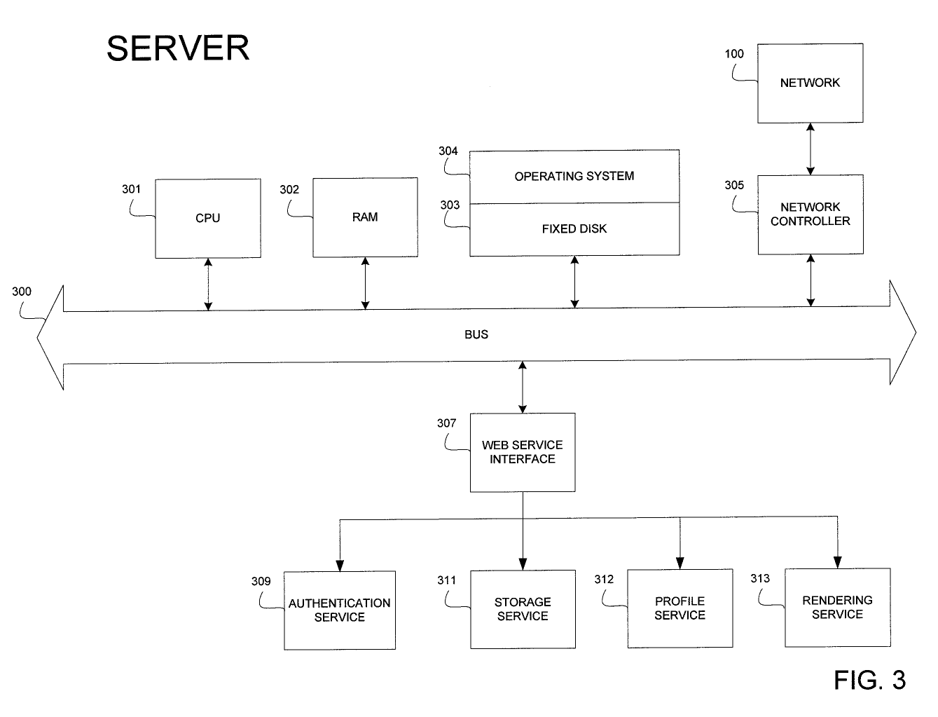

FIG. 3 is an exemplary configuration of the internal architecture of server 106. CPU 301, RAM 302, fixed disk 303, network controller 305 and web service interface 307 are interfaced to bus 300.

CPU 301 performs instructions from computer programs stored on the RAM 302 or fixed disk 303. RAM 302 also provides temporary storage for image data and job profiles. Fixed disk 303 includes operating system 304 such as Microsoft® Windows Server 2003. Network controller 305 enables server 106 to communicate with network 100. Web service interface 307 provides additional applications to server 106 by interfacing to a plurality of web services such as authentication service 309, storage service 311, profile service 312, and rendering service 313. The above web services are web-based applications. However, the present invention is not limited to web services, and any applications that enable practice of the present invention may be employed.

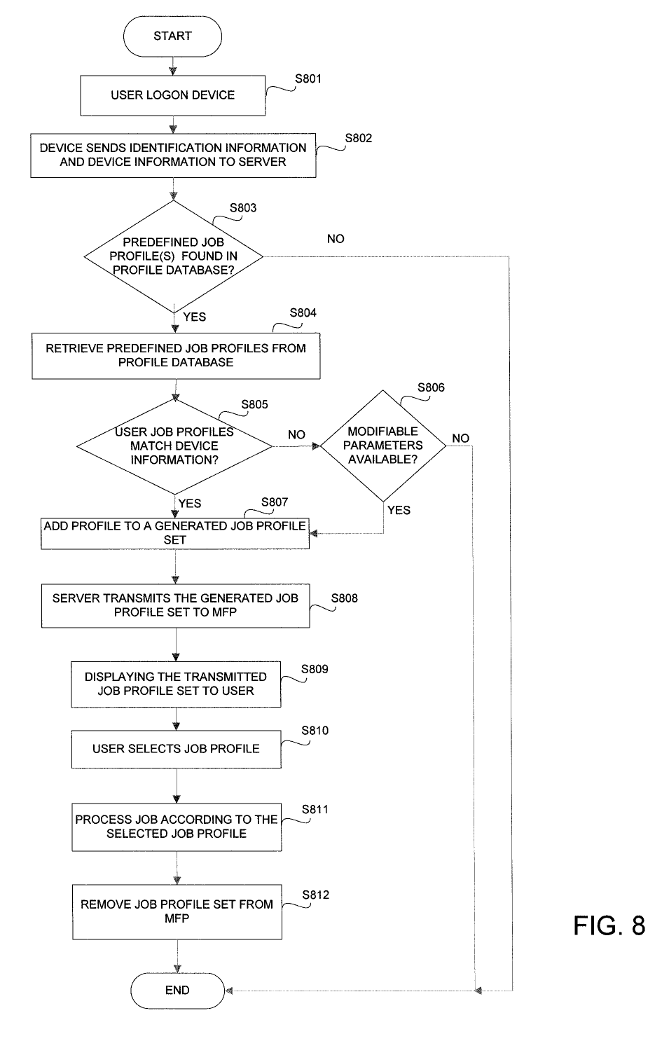

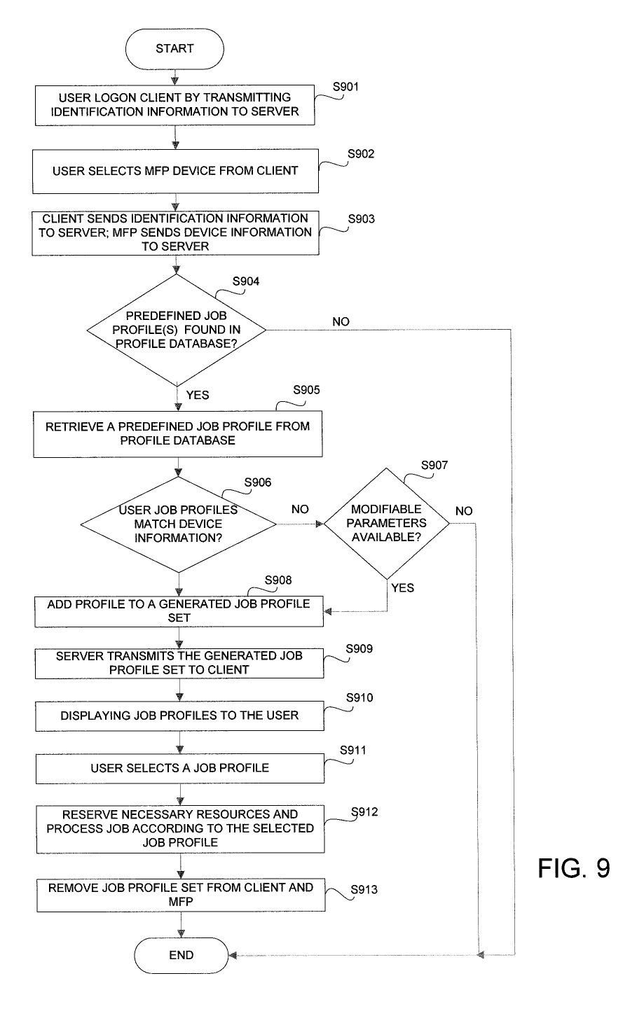

Authentication service 309 provides user and device authentication via secure agent (SA) for ensuring that data stored in server 106 cannot be obtained by any unauthenticated/unauthorized individual. Storage service 311 provides storage and retrieval of information, such as image data and job profiles, from profile database 105. Profile service 312 provides application for generating a profile set using identification information and device information, which will be explained in more detail below in connection with FIG. 8 and FIG. 9. Rendering service 313 allows server 106 to render a file in accordance with a job profile and send the rendered file to an intended MFP device for processing.

FIG. 4A is an exemplary graphical user interface of a profile application for viewing a job profile. Job profiles can be created or modified using a profile application. In the present embodiment, the profile application is installed on client 101. In another embodiment, the profile application may be installed on an MFP device. In the case that the job profile application is installed on an MFP device, a user can create or modify personalized job profiles from a touch panel of the MFP device. In yet another embodiment, the profile application may be a web application, thus enabling access of the job profile application from any web-enabled device. The location of the job profile information is not limited to these described locations, and can be located anywhere that would enable practice of the present invention.

Users may personalize and store job profiles by creating job profiles with a profile application and storing the job profile in profile database 105. In the present embodiment, profile database 105 is a SQL-based storage system, but is not limited to such, and any database system that would enable practice of the present invention is applicable.

To view existing job profiles for an operation, a user first selects a job function such as scan 402 of FIG. 4A. Upon selection of the scan 402 function, the job profile application obtains all of the scan profiles and displays the profiles in a job profile display section 407 of the user interface. To view the attributes of a specific job profile, the user selects the desired scan profile, such as “Scan Job Profile 1”, from the job profile display section 407. The attributes of “Scan Job Profile 1” are then displayed to the user in a job profile attribute section 408 of the user interface.

The user can add new profiles and modify existing profiles by selecting the corresponding feature, such as “New Profile” 406 and “Edit Profile” 405 button shown in FIG. 4A. Likewise, user may view print job profiles by selecting print 401, copy job profiles by selecting copy 403, and fax job profiles by selecting fax 404.

FIG. 4B illustrates an exemplary graphical user interface for adding/modifying a job profile in a profile application. To create a job profile, a user first selects a job function from 409-412. After selecting the desired job function, associated job parameters are made available for selection via selection field 413. The job parameters include, but are not limited to color mode, file type, pages per file, data type, resolution, and ratio. In addition, job profiles may be further configured to transfer a document to at least one destination, such as a recipient or remote storage, by using at least one type of transport protocol. The types of transport protocols typically include at least electronic mail (email) and file transfer protocol (ftp). Upon selecting the desired job parameters, the user may save the job profile in profile database 105 using storage service 311 by selecting “SAVE PROFILE” button in 414, or cancel the job profile configuration by selecting “Cancel” button 415.

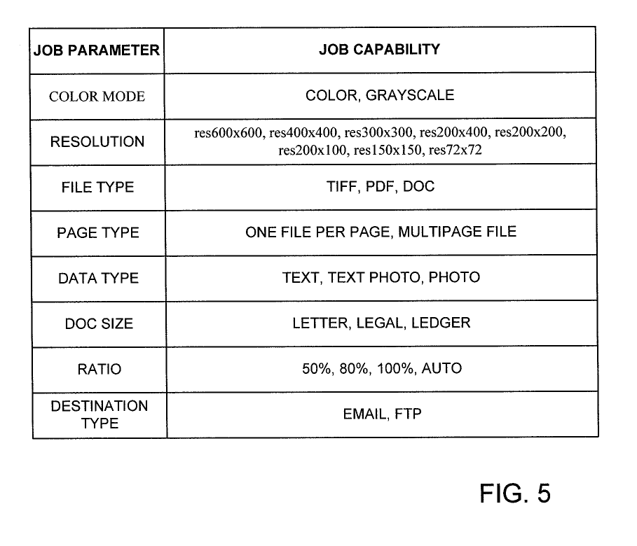

FIG. 5 is an exemplary table for defining job parameters and their associated job capabilities. Color mode includes the options of color and grayscale. Resolution includes various resolution options such as res600×600, res400×400, res300×300, etc. File type includes file format such as tiff, pdf and doc. Page type includes options such as one file per page and multi-page file. Data Type includes data quality such as text, text/photo and photo. Doc Size includes document sizes such as letter, legal and ledger. Ratio includes 50%, 80%, 100% and “Auto”, wherein “Auto” automatically adjusts the ratio according to Doc Size. Destination type includes transport protocol for transporting image data, such as email and file transport protocol (FTP). The job parameters shown in FIG. 5 are only for illustrative purpose, and any other job parameters that would enable practice of the present invention are applicable.

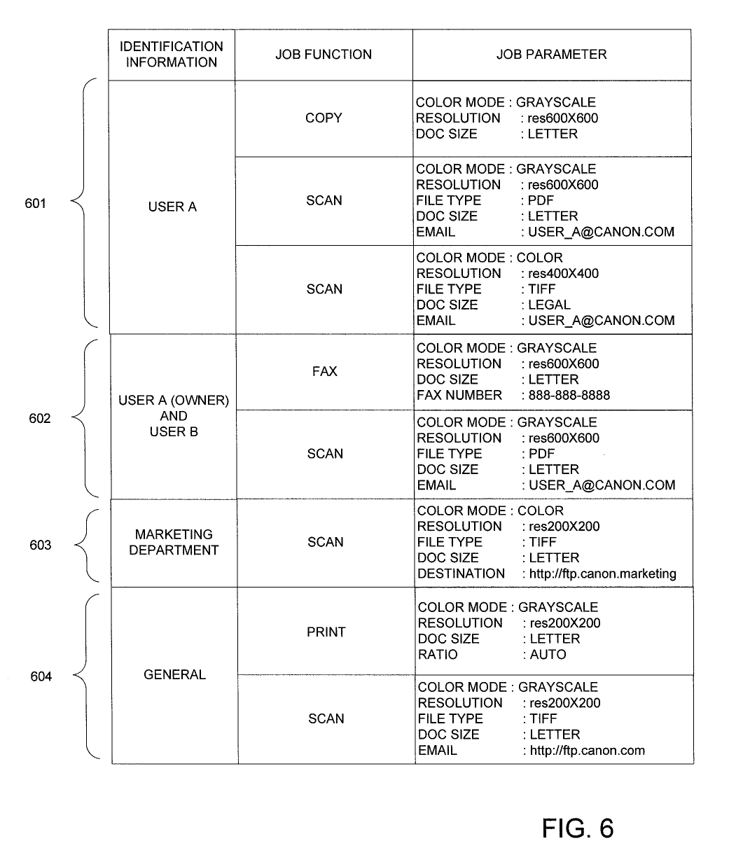

FIG. 6 illustrates an exemplary configuration of the job profiles stored in profile database 105. The identification information field of a job profile contains the ownership information of a job profile. Typically, the identification information contains the identification information of the user who created the job profile, such as USER A in 601. However, the owner of the profile (i.e. the creator of the profile) may grant access rights of the job profile to a plurality of users. For example, in 602, User A (the owner of the job profiles) granted access to User B. Therefore, both User A and User B are shown in the in identification information field of the job profiles in 602. Alternatively, the job profile may be configured using group identification information such as the Marketing Department shown in 603. Identification information contains the ownership information as well as access rights information of the job profile.

Also in FIG. 6, 604 comprises a set of general job profiles that are configured for general users of an MFP device. The general job profiles contain the set of job parameters that are the most commonly used. Any user of the MFP can access the general job profile set. In another embodiment, the general job profile can be configured according to identification information (i.e. user identification information or group identification information) by a network administrator. For example, the network administrator can set up general job profiles exclusively for members within a particular department (i.e., advertising, legal, etc.). These general job profiles may contain the set of parameters that are the most commonly used by a particular department. As described, the job profiles stored in profile database 105 can be user job profiles, group job profiles or general job profiles. The present invention is not limited to these types of job profiles, and any type of job profile that would enable practice of the present invention is applicable. As shown in FIG. 6, multiple job profiles can be associated with the same identification information. Each of the job profiles correspond to a specific job function (e.g. scan, copy, print, and fax) of a typical MFP device. Job Parameter contains detail information of each job profile. In the present embodiment, job profiles are stored in profile database 105 in an Extensible Markup Language (XML) format. However, any format that would enable practice of the present invention is applicable.

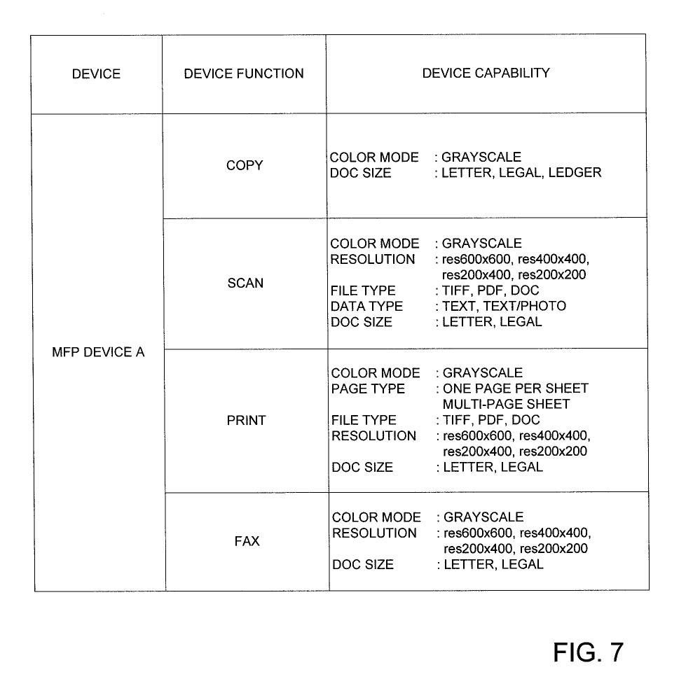

FIG. 7 is an exemplary configuration of device information. Device information is generated by an MFP device according to its current status. Device information typically includes device function and device capability, which, in the present embodiment, are in an XML format. Device information according to the present invention is not limited to device function and device capability and the format of the device information is not limited to XML.

Device function includes functions such as copy, scan, print, fax, or any other function associated with the intended device. Device capability typically includes capability according to the intended device's current status. For instance, presume MFP device 102 supports legal, letter, and ledger sized paper for printing and copying. However, at a specific point in time, only legal size paper is available. At that point, only legal size paper will appear in the MFP device's 102 device capability information. Furthermore, if sensors 217 are attached to the paper trays of the MFP device 102, it is possible to find the exact number of sheets of paper that are available in the MFP device 102.

FIG. 8 illustrates an exemplary flow diagram for generating and using job profiles from an MFP device. The flow begins with a user logging onto an MFP device, such as MFPs 102-104, in step S801 (for illustrative purposes, MFP device 102 will be referred to for the remainder of the discussion on FIG. 8). The user logs onto MFP device 102 by entering the user's identification information (e.g., username and password) at the MFP device's 102 user interface. The user's identification information is then verified by authentication service 309.

The user's identification information may also be provided by swiping a magnetic stripe card or smartcard through a card reader associated with the MFP device 102. The method of providing the user's identification information is not limited to the above described methods, and any method for providing identification information is applicable. In addition, the user's identification information is not limited to a username and password. The identification information may be group identification information such as a department identification name. For example, in the group identification scenario, a group of users may share the same set of job profiles by logging onto MFP 102 using group identification information. The contents of the identification information are not limited to what is described above, and any type of identification information that would enable practice of the present invention is applicable.

Turning back to FIG. 8, in step S802, after receiving the user identification information, the MFP device 102 sends the entered user identification information and its device information to server 106. As described above, the MFP device 102 generates a set of device information of its current capabilities, such as its available color mode, resolution, file type, page type, data type and document size as described in FIG. 7.

In one embodiment, device information consists of static information and variable information. Static information is typically related to the hardware configuration of the device, such as color mode, image resolution, file type, data type, image ratio, etc. This information does not usually vary. On the other hand, variable information is information associated with the device that can vary at any given time, such as available paper size, ink, staples, etc. If the MFP device 102 has previously transmitted its static information to server 106, e.g., upon initialization of the MFP device 102, subsequently, the MFP device 102 would typically only transmit its variable information to server 106.

In another embodiment, if no variable information has been changed or modified, the MPF device 102 does not need to send any variable information to server 106.

Next, in step S803, a determination is made whether predefined job profiles associated with the user identification information provided by the MFP device 102 are available in profile database 105. The predefined job profiles may be user job profiles as depicted in FIG. 6. The predefined job profiles may also include group job profiles or department job profiles as previously described. If in step S803, it is determined that no job profiles are available in the profile database 105, in one embodiment, an empty job profile set will be returned by server 106. In another embodiment, a message will be displayed on display 215 notifying the user that no predefined job profiles are available. In still yet another embodiment, an empty job profile set will be returned and a message will be displayed notifying the user that no job profiles are available.

If however, in step S803, it is determined that job profiles are available, flow proceeds to step S804. In step S804, server 106 obtains the predefined job profiles from profile database 105. Next in step S805, server 106 determines whether any of the job profiles obtained in step S804 match the device information received in step S802. As previously described with respect to FIG. 7, device information contains the current capabilities of the MFP device 102. Consequently, if the obtained job profiles match the device information, the matching job profiles contain job parameters that correspond to the device's current capabilities.

If, in step S805, the predefined job profiles obtained in step S804 match the device information, flow proceeds to step S807 where a job profile set containing all the obtained job profiles is generated.

However, if in step S805, none of the predefined job profiles obtained in step S804 match the device information, then flow proceeds to step S806. In step S806, by using device information, server 106 can generate a set of modifiable attributes. For example, take the case where an obtained job profile requires color scanning capability but the MFP device 102 does not support color scanning. The MFP device 102 can modify the obtained job profile for grayscale scanning. In another scenario, if the image to be printed does not fit on a letter sized paper, the modifiable attributes can re-size the image by modifying the image ratio or allow server 106 to automatically re-size the image. Subsequently, the modified job profile is included in the job profile set generated in step S807. In one embodiment, server 106 automatically modifies the job profile according to the modifiable attributes. In this embodiment, the modified job profile will indicate which parameters have been modified from the original job profile, and present the modified job profile to the user. In another embodiment, server 106 does not automatically modify the job profiles according to the modifiable attributes. Instead, the set of modifiable attributes is presented to the user in display 215, and the user selects the desired job parameters.

In the case where no modifiable attributes are available, in one embodiment, an empty job profile set will be returned by server 106. In another embodiment, a message will be displayed on display 215 notifying the user that no predefined job profiles are available. In still yet another embodiment, an empty job profile set is returned along with a message notifying the user that no job profiles are available.

After server 106 generates a job profile set, the job profile set is transmitted to the MFP device 102 in step S808, and displayed to the user in step S809. In the present embodiment, the transmitted job profile set is displayed on display 215 of the MFP device 102. Next, in step S810, a user selects a job profile from the displayed job profile set to perform a job.

In step S811, the MFP device 102 obtains the selected job profile from server 106 and process the job according to the selected job profile. In step S812, upon completion of the job, the obtained job profiles and the generated job profile set is removed from the MFP device 102.

FIG. 9 depicts another embodiment of the present invention. FIG. 9 is an exemplary flow diagram for generating and using a job profile from client 101. The flow begins in step S901 with a user logging onto client 101 by providing identification information (e.g., manually entering user credentials, swiping a magnetic stripe card or smartcard, etc.) to client 101. Client 101 transmits the identification information to server 106, where it is verified. In the present embodiment, the identification information is verified by authentication service 309.

After the user is authenticated, the user proceeds to generate a document (e.g., generate a document using a word processor application). Following generation of the document, in step S902, the user selects a desired MFP device (MFP device 102) for printing the document. Upon selection of the MPF device 102, client 101 sends the identification information to server 106 and the MPF device 102 sends its device information in accordance with its current capabilities to server 106 in step S903. Based on the received user identification information and device information, server 106 obtains a set of predefined job profiles from profile database 105.

In steps S904 to S908, server 106 generates a job profile set as described above in connection with steps S803 to S807 of FIG. 8.

After server 106 generates a job profile set, the job profile set is transmitted to client 101 in step S909. In step S910, the transmitted job profile set is displayed on client 101. In step S911, a user selects a job profile from the displayed job profile set to perform a job.

After the user selects a job profile in S911, the MFP device 102 reserves the necessary resources according to the selected job profile in S912. Thus, the resources of the MFP device 102 associated with attributes specified in the job profile selected by the user are made unavailable to other operations until the operation performed by the operation unit is completed. For instance, if a print job requires 50 sheets of letter-size paper, the MFP device 102 will reserve the 50 sheets of letter-size paper and thus prevent other operations from using the 50 sheets of paper to perform a print job. In the present embodiment, the amount of available resources (i.e. paper) is detected by sensor 217.

After reserving the necessary resources, the MFP 102 processes the job according to the selected job profile. Upon completion of the job, in step S913, the generated job profile set is removed from client 101 and the MFP device 102.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

What is claimed is:

1. A method for generating a job profile set, comprising:
receiving identification information;
receiving device information;
obtaining at least one job profile based on the received identification information and the received device information; and
generating the job profile set,
wherein the generated job profile set includes the at least one job profile.

2. The method according to claim 1, wherein the at least one job profile is stored in a profile database.

3. The method according to claim 2, wherein the at least one job profile is stored in the profile database from a location remote from the profile database.

4. The method according to claim 1, wherein a job profile contains parameters for performing a job.

5. The method according to claim 4, wherein the parameters vary based on the job to be performed.

6. The method according to claim 1, further comprising generating a modified job profile set from the at least one job profile based on device modifiable information.

7. The method according to claim 1, wherein the device information includes at least job functions that can be performed by a device and associated capabilities of the device.

8. The method according to claim 7, wherein the device is an image reproduction device.

9. The method according to claim 8, wherein the job functions include copying, scanning, printing, and faxing.

10. The method according to claim 7, wherein the device capabilities vary depending upon the job function.

11. The method according to claim 10, wherein the device capabilities vary depending upon the current status of the device.

12. Computer-executable process steps for causing a computer to execute the method of claim 1.

13. A computer-readable storage medium for storing the computer-executable process steps of claim 12.

14. A system for generating a job profile set, comprising:
a receiving unit configured to receive identification information and device information;
an obtaining unit configured to obtain at least one job profile based on the received identification information and the received device information; and
a generating unit configured to generate a job profile set,
wherein the generated job profile set includes the at least one job profile.

15. The system according to claim 14, wherein the at least one job profile is stored in a profile database.

16. The system according to claim 15, wherein the at least one job profile is stored in the profile database from a location remote from the profile database.

17. The system according to claim 14, wherein a job profile includes parameters for controlling a job.

18. The system according to claim 17, wherein the parameters include at least one of the following: color mode, resolution, file type, page type, data type, document size, and image ratio, or destination information.

19. The system according to claim 14, wherein the generating unit is further configured to generate a modified job profile set from the at least one job profile based on device modifiable information.

20. The system according to claim 14, wherein the device information includes device capabilities of an image reproduction device.

21. The system according to claim 20, wherein the device capabilities include at least one of the following: color mode, image resolution, file type, page type, data type, document size, or image ratio.

22. A system for generating and using a job profile set, comprising:
a creating unit configured to create at least one job profile;
a first transmitting unit configured to transmit the at least one job profile to a profile database;
a first receiving unit configured to receive identification information and device information;
an obtaining unit configured to obtain at least one job profile based on the received identification information and the received device information;
a generating unit configured to generate a job profile set from the at least one job profile obtained by the obtaining unit based on the device information received by the receiving unit;
a second transmitting unit configured to transmit the job profile set generated by the generating unit; and
a second receiving unit configured to receive the job profile set transmitted by the second transmitting unit.

23. The system according to claim 22, further comprising a selection unit configured to select at least one job profile from the job profile set transmitted by the second transmitting unit.

24. The system according to claim 23, wherein further comprising an operation unit configured to perform an operation using the at least one job profile selected by the selection unit.

25. The system according to claim 24, wherein the operating unit is a part of an image reproduction device.

26. The system according to claim 25, wherein resources of the image reproduction device associated with attributes specified in the job profile selected by the selection unit are made unavailable to other operations until the operation performed by the operation unit is completed.

27. The system according to claim 25, wherein the job profile set is removed from the image reproduction device after an operation using at least one job profile from the job profile set transmitted by the second transmitting unit is completed.

28. The system according to claim 25, wherein the job profile set is removed from the image reproduction device after a predefined period of time has elapsed.
